(19) United States
(12) Patent Application Publication
(10) Pub. No.: US 2026/0138348 A1
(43) Pub. Date: May 21, 2026

(54) ARRANGEMENT TO MOUNT ONTO A HORIZONTAL-TYPE AUTOMATIC ADHESIVE-FREE CORRUGATED CARDBOARD BOX MACHINE AND BOX MOUNTING METHOD

(71) Applicant: CARTOCOR S.A, Arroyito (AR)

(72) Inventor: Ignacio GROSSO, Arroyito (AR)

(21) Appl. No.: 19/304,860

(22) Filed: Aug. 20, 2025

(30) Foreign Application Priority Data
Aug. 20, 2024 (AR) P20240102203

(51) Int. Cl. B31B 50/73; B31B 50/48; B31B 100/00; B31B 110/35; B31B 120/70

(52) U.S. Cl. CPC B31B 50/732; B31B 50/48; B31B 2100/00; B31B 2110/35; B31B 2120/70

(57) ABSTRACT

An arrangement to mount a horizontal-type automatic corrugated cardboard box machine mounting which comprises a variety of locks and interlocks to achieve an adhesive-free assembly. In the preferred embodiments, the box contains 8 locks and 8 interlocks. In the first embodiment, the display arrangement is used to mount boxes with a rectangular base and beveled corners, while in the second embodiment, it is used to assemble boxes with a rectangular base. The invention further comprises methods to automatically assemble cardboard boxes with locks and interlocks by means of each of the embodiment arrangements.

### FIELD OF INVENTION

This invention relates to a horizontal-type automatic corrugated cardboard box mounting machine that assembles corrugated cardboard boxes with a unique locking and interlocking design, allowing rapid assembly free of any adhesives or glues. The invention also includes a box assembly method using this system.

### BACKGROUND OF THE INVENTION

The following documents are known in the previous art:

Document U.S. Pat. No. 6,179,204B1 discloses a tray that is assembled by an automated device from a die-cut blank. The tabs on the opposite ends of the side pieces are rolled into rolled ends. A serrated edge on a distal edge of each rolled end is placed in a cut and flattened area to interlock the distal edge with the blank and form a tray with interlocked walls. The serrated edge does not penetrate the die-cut blank, thus providing a leak-proof interlocked tray. Perforations define several fold lines to facilitate the use of automated equipment to form the tray. Non-stick paper is placed in the center of the tray, and the batter is placed on the non-stick paper. The batter can be baked to form a cake while still in the tray.

Document U.S. Pat. No. 2,832,270 discloses a device for converting blank parts from flat cut and slotted box blanks, particularly lined blanks with side panels of a predetermined height, into a hollow box shape. The device comprises an alternating plunger and a die through which said plunger can move, including an underside surface that engages the blank and two substantially vertical opposite side surfaces relative to said underside surface, against which side surfaces the side panels of the blank fold as the plunger passes through the die. Additionally, the plunger includes a retractable and projectable finger, mounted on the plunger to move in a substantially vertical plane relative to the underside surface and substantially normal to a side surface of the plunger. Such finger points downward and is at a 60 distance from the bottom plus such height, except for the tip of the finger which is at a shorter distance than such height to clear the structure of the side panel in the box's corner and to mount onto de external surface of the adjacent side panel to its upper edge when retracted. Such plunger includes a fixed adjacent element to such finger, between such finger and the corner of the closest corner of the plunger. Such fixed element has a blank supporting surface of the side panel. Such fingertip is mobile when beyond such element and up to a position under such portion of the surface when it is retracted. There are controlled means by the plunger path to move such finger.

Document U.S. Pat. No. 3376797A describes a device for erecting cardboard boxes from flat blanks, where these boxes consist of a bottom panel and pairs of opposite side wall panels connected to the bottom panel margins via slotted lines. The panels of the side walls of one of such pairs have slots in them, adjacent to their relevant opposite end portions and the panels of the other pair have adapted tabs to fold around such opposite ends of such panels of the side wall mentioned in the first place to interlock the structure of the corner of the box.

The device, in combination, includes a die structure and a mandrel structure. Such mandrel structure includes a portion of plate which is generally rectangular and with an adapted lower surface to mount on a lower panel of a blank part of cardboard inside the lines of the slots defining such panel. This means mounting such mandrel structure to achieve alternate movement through such die structure, which comprise guiding blocks with surfaces configured to fold such opposite pairs of such wall panels towards substantially straight angles in relation to such lower panel as the blank part passes through the die structure, and certain of such guiding blocks adjacent to the corners of the blank part with surfaces configured to fold such tabs around the outer surfaces of such panel of the wall with hollow spaces, as well as means to interlock end portions of such tabs through such relevant slots as one of the final operations while assembling the cardboard box.

Such said means include a pair of arms that have a pair of arms having their proximal ends pivotally secured to a portion of said mandrel structure, one on each side thereof, a tab closure member secured to the distal end of each of said arms and having prongs that extend in directions opposite thereto to press against areas of the slotted panels towards the interior of said slots to simultaneously open said slots for the reception of said tabs and to overlap the incoming terminals of said tabs when they enter the slots, and finally fitting said end portions through the slots to interlock the corner structure of the carton; and cooperating means in said arms and in said die structure for moving said tab closing member towards the interior of the case to achieve said quick closing action.

U.S. Pat. No. 2,919,633 (A) discloses a device for bending and locking the corners of a folding box comprising a front wall, a rear wall and opposite end walls with locking flaps for folding and partially inserting into curved indentations in the front and rear walls. Such indentations form tabs in the walls. Said locking fins include a locking projection that extends beyond the limits of said tab, which projection must be forced from a position superimposed on the respective wall panel to an underlying position in the whole box. The device comprises a plunger having a substantially rectangular bottom area, vertical end walls and vertical front and rear walls. Said front and rear walls being provided with knob-shaped projections in a position to abut against a portion adjacent to a slit in a blank erected around said plunger. Such plunger has further recesses extending into the body of the plunger between said knob-shaped projections and the corners of the plunger. Such recesses are open at their lower parts. There is a die through with the plunger can be moved, which has side portions substantially extending in parallel to the front and rugged walls of the plunger and end portions substantially in parallel to the end walls of the plunger. Considering the plunger and the die in a plant view, each of such side portions comprising a side lane which have throat elements on it, which define a die throat through which such plunger goes through. Such throat elements are cut in front of such projections in a knob shape for the width of the projections in relation to the die as the plunger passes through the die, the projectable and retractile finger elements, in such side rails in line with the holes in the plunger. Such finger elements are located in order to lean onto the blocking projections of the blank part when the plunger is in its deepest inlet position into the die, spring means for retracting said finger elements to a position outside the rectangular contour of the bottom of the plunger, a depressible actuator mounted on each of said rails for projecting the respective finger elements to a position within the rectangular contour of the bottom of the plunger within of the gaps by pressing them from the actuator, and means for mounting the side rails so that they move towards and away from each other to allow temporary widening of the throat of the die; and an arm on said plunger for engaging and depressing said actuators near the end of the downward stroke of the plunger to force the locking projections to said underlying position. The reach of such arms is large enough to hit such actuators in the position in which the die throat is narrowed, as well as in the position in which the die throat is temporarily widen.

The document US2012208686 (A1) describes a device to assemble cardboard boxes which is a device to fold four panels making up a section of a cover of a cardboard box, forming an overlapping cover where each of the four panels overlap to the adjacent of the four panels. The carton assembly apparatus is provided with release members, locking members and moving devices. The ejecting members eject the respective first portions of the four panels. The locking members lock the respective second portions of the four panels, preventing the second portions from moving in ejection directions. The ejection directions refer to the ejection directions of the four panels. The motor devices move the locking members in a direction that includes at least one vertical direction component.

The document ES2012935 (A6) describes a mechanism comprising one general frame onto which the following are positioned: A) the automatic supply mechanism for CT stamped cardboard pieces, which is composed of reception and stacking, individual gripping, displacement, positioning and centering devices on mounting platform 9; B) the automatic corner supply mechanism ac, which is composed of the guiding, individual displacement, gripping and location devices 11; C) the automatic cardboard box forming mechanism CC, which is composed of the devices for holding, unfolding the four corner tabs, lifting the four walls of the box and forming the corner columns 16; D) the automatic PT carton box removal mechanism, which is composed of pushing and translation devices, stacking and evacuation of finished products.

The document ES1059503 (U) discloses a device to fold the corners of cardboard boxes, comprising an engine element, such as a pneumatic cylinder which makes a pivotal arm turn, and has a terminal element to fold the parts of cardboard boxes, such as flaps of reinforcement columns; pivotal arm combining rotary and axial movements simultaneously by means of rotating a vertical cylindric axes joined at the bottom to an end of a pivotal arm. This means that a central portion of such cylindrical axes is mounted onto the hole of a main support, and such pneumatic cylinder is mounted onto a long support. The main support is comprehensive. It is characterized by the fact that the long support (16) supporting the set of the device is mounted in a dismountable fashion and can be adjusted to a side part (18) common to the set of a box assembly machine, while the tilting arm is removable and is made up of at least two pieces that are also removable and adjustable with relative movement relative to each other; all in order to be able to adjust the device adapting it to the geometry and size of the box and reinforcement columns to be formed.

The document ES2839552 (A2) discloses a machine and a method of cardboard box assembly based on flat die-cut plates, and the cardboard box. The machine (100) comprises a male connection (60) in the shape of an inverted truncated pyramid, movable in the linear direction Z towards a mold (50) with forming stops (56), movable between the respective retracted and stop positions to evacuate the boxes (B) of the mold (50) through an outlet mouth (55) opposite to a plate inlet mouth (54), the forming stops (56) having concave curved surfaces (S2), complementary to curved surfaces convex (62a′) with inverted conical shape located in four corner areas of the male (60); a conveyor with a rotational encoder (13) coupled to a rotary motor (12) configured together to controllably move a pusher member (16) of the plate (P) along linear guides (40); and pressurizable glue injectors (45) configured to deposit glue (CC) on the plate (P) during transport.

The document U.S. Pat. No. 2,860,549 (A) describes a packaging machine that can form a blank box into a finished box; said box blank comprising a rectangular base portion and side and end wall portions foldably secured to said base portion, support means operable to support a supply of box blanks. A ram assembly mounted adjacent to said support means support for movement between opposite limit positions, operable drive means. Actuating said ram assembly between said opposite limit positions means defining a die opening placed in axial alignment with said ram assembly in which said ram assembly projects during movement towards one of said limit positions, a box shuttle in blank operable to transfer a box blank from said support means to a position superimposed on said die opening with the rectangular base portion of the box blank coextensive with the die opening, and a plurality of forming edges on said blank box shuttle and adjacent to said die opening operable during movement of said ram assembly to said limit position engages the side and end walls of the preformed box and bends it upward with respect to the base portion of the preformed box.

### SUMMARY OF THE INVENTION

The invention consists of an assembly system for mounting on an automatic horizontal machine for assembling two types of corrugated cardboard boxes:
a) boxes with a rectangular base and beveled corners and
b) boxes with a rectangular base (namely, without beveled corners),
   where box types have multiple locks and interlocks, optimally featuring 8 locks and 8 interlocks for rapid assembly without adhesives.

This system is designed for use with horizontal assembly machines.

### BRIEF DESCRIPTION OF FIGURES

FIG. 1 shows an exploded view of the lock actuation arrangement of the horizontal assembly arrangement for the box with a rectangular bottom with beveled corners.

FIG. 2A shows the action of the mandrel on the corrugated cardboard sheet, before entering the forming machine, of the horizontal assembly arrangement for the box with a rectangular bottom with beveled corners.

FIG. 2B shows the action of the mandrel on the corrugated cardboard sheet, entering the former of the machine, of the horizontal assembly arrangement for the box with a rectangular bottom with beveled corners.

FIG. 2C shows the corrugated cardboard sheet, inside the machine former and the mandrel withdrawing, in the horizontal assembly arrangement for the box with a rectangular bottom with beveled corners.

FIG. 2D shows the corrugated cardboard sheet, inside the machine former, with the turners activated, of the horizontal assembly arrangement for the box with a rectangular bottom with beveled corners.

In FIG. 2E, 2E-1-2E-6 show the mounting sequence of the box with a rectangular base and beveled corners in the horizontal assembly arrangement.

FIG. 3 shows an exploded view of the lock actuation arrangement of the horizontal assembly arrangement for the box with a rectangular base.

FIG. 4A shows the action of the mandrel on the corrugated cardboard sheet, before entering the forming machine, of the horizontal assembly arrangement for the box with a rectangular base.

FIG. 4B shows the action of the mandrel on the corrugated cardboard sheet, entering the forming machine, of the horizontal assembly arrangement for the box with a rectangular base.

FIG. 4C shows the corrugated cardboard sheet, inside the former of the machine, the turning plates beginning to act and the mandrel withdrawing, in the horizontal assembly arrangement for the box with a rectangular base.

FIG. 4D shows the corrugated cardboard sheet, inside the machine former, with the activated turning plates in the horizontal assembly arrangement for the box with a rectangular base.

FIG. 4E shows the assembly sequence of the P-84/1 format box, using the horizontal assembly arrangement for the box with a rectangular base.

The difference between the devices for assembling boxes with a rectangular base with beveled corners and boxes with a rectangular base (that is, without beveled corners) lies in:
The geometry and angle of rotation of the turners: for boxes with a rectangular base with beveled corners the turners rotate 90°, and for boxes with a rectangular base the turners rotate 180°.
The presence of deflectors: due to the geometry and way of folding the box with a rectangular base with beveled corners, it is necessary to use deflectors that generate a pre-folding; In the rectangular bottom box, this is not necessary.

### DETAILED DESCRIPTION OF THE INVENTION

### Assembly of Box with Rectangular Base and Beveled Corners, 8 Locks and Interlocks—Horizontal Assembly

In a preferred embodiment, the arrangement of this invention is described by way of example for the assembly of boxes with 8 locks and 8 inserts. However, its structure is suitable for the assembly of boxes with rectangular bases and beveled corners that have other amounts of locks and inserts since only the number of elements that make up the arrangement will vary.

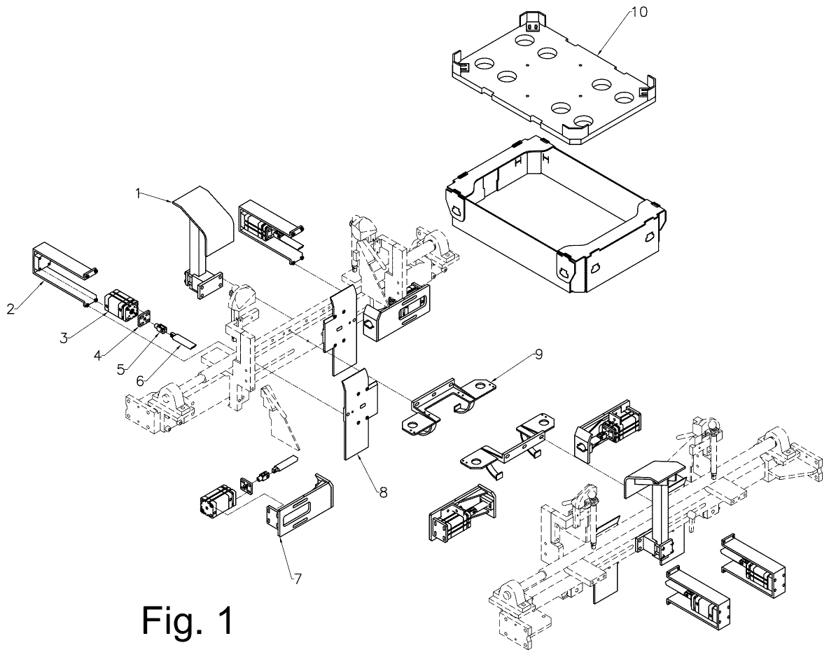

FIG. 1 shows an exploded view of the horizontal assembly arrangement lock actuation arrangement for the box with a rectangular base with beveled corners with 8 locks and interlocks of the first embodiment of this invention.

These components, collectively known as the machine's forming system, are illustrated with dotted lines for existing parts on known machines and solid lines for all uniquely designed parts forming the assembly system in this embodiment. For example, in a design for the assembly of boxes with 8 locks and 8 interlocks:

Deflectors 1. (qty: 2)

Front Cylinder Supports 2. (Qty: 4)

Actuating Cylinders 3. (Qty: 8)

Position Adjustment Plates for Fingers 4. (Qty: 8) Anchoring Forks 5. (Qty: 8)

Interlocking Fingers 6. (Qty: 8)

Lateral Cylinder 7. (Qty: 4)

Forming Plates 8. (Qty: 4)

Turners 9. (Qty: 2)

Mandrel 10. (Qty: 1)

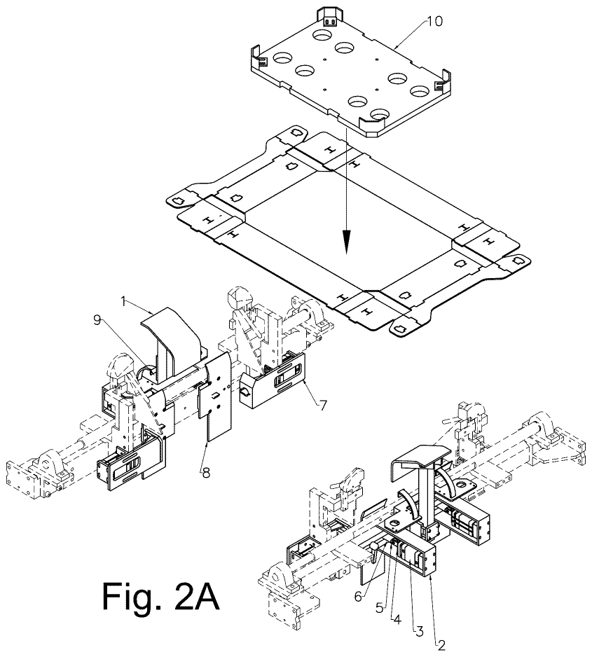

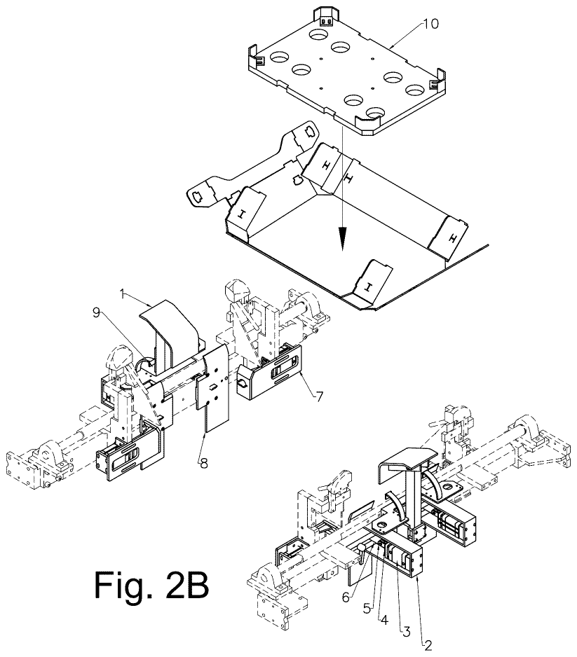

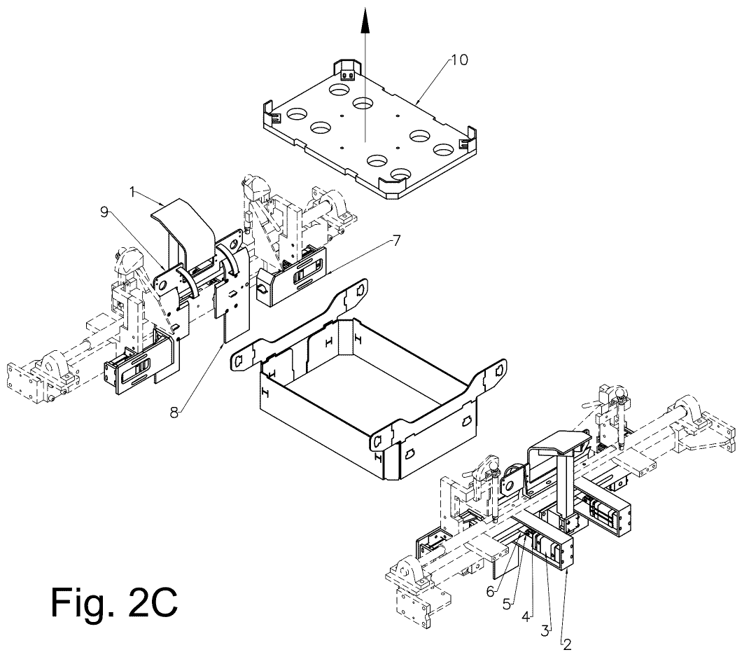

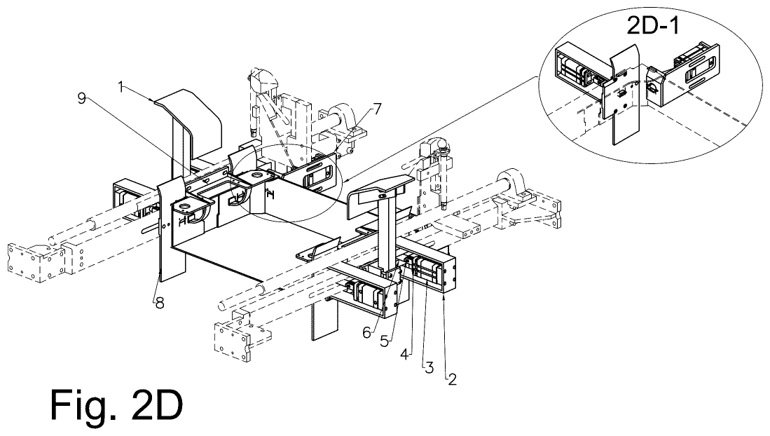

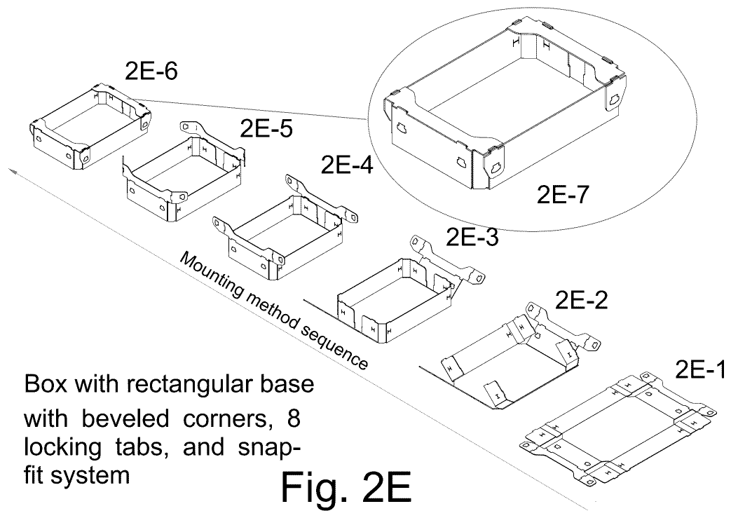

FIG. 2A shows the action of the mandrel on the corrugated cardboard sheet, before entering the forming machine.

FIG. 2B shows the action of the mandrel on the corrugated cardboard sheet, entering the forming machine.

FIG. 2C shows the corrugated cardboard sheet inside the machine former and the mandrel being removed.

FIG. 2D shows the corrugated cardboard sheet, inside the machine former, with the turners activated. In the detail you can see the corner of the box in a dotted line and the interlocking finger

FIG. 2E shows the assembly sequence of the rectangular bottom with beveled corners with 8 locks and inserts, starting as a flat corrugated cardboard sheet in FIG. 2E-1, until reaching a shaped box in FIG. 2E-6. The sequence 2E-1 to 2E-5 is armed with conventional systems. In the position 2E-6, the interlocking fingers act. The display of this invention has been conceived to be mounted on different existing own design box assembly machines. Such known machines are suitable for assembling cardboard boxes and join them with a hot-melt type adhesive. The arrangement of this invention allows such machines to assemble cardboard boxes without any adhesives.

The arrangement is made up of several mechanical parts of our own design and commercial pneumatic cylinders. The combination of all the pieces enables the transversal movement of pieces called the machine's locking fingers, which perform the individual locking of each box lock.

Each box lock corresponds to a pneumatic cylinder, which, when activated, transmits movement to each of the machine's locking fingers that insert the box locks into the corresponding die-cut. When the locking fingers are removed (through pneumatic retraction), each box lock is engaged in its position, allowing the box assembly to be fixed.

The parts numbered and described in FIG. 1 are part of the arrangement of the special assembly kit that forms this embodiment of the arrangement of the present invention.

The deflectors 1 perform the initial folding of the box when the mandrel 10 pushes the corrugated cardboard sheet onto the former.

Once the box is folded inside the former formed by the forming plates 8, the turners 9 are activated, folding the upper part of the box (roof). After completely folding, the actuating cylinders 3 (ADNGF 40-40) activate the locking fingers 6, leaving the box locked in its position.

By means of the elements of this invention, the assembly of the box is performed through mechanic movements without needing any kind of adhesive whatsoever.

The sequence of the assembly method of the second embodiment is as follows:
1.—The box is assembled by introducing it inside the former by means of the mandrel 10 in FIG. 1;
2.—The turners 9 are activated folding the upper part, i.e., the roof of the box;
3.—The lateral and front locking fingers 6 (total 8 push fingers) are operated by means of pneumatic cylinders 3; this action is carried out with the turners 9, in the folded position.

### Assembly of Rectangular Base Box with 8 Locks and Interlocks—Horizontal Assembly

In a preferred embodiment, the arrangement of this invention is described by way of example for the assembly of boxes with 8 locks and 8 interlocks. However, its structure is suitable for the assembly of boxes with a rectangular base that has other amounts of locks and interlocks since only the number of elements that make up the arrangement will vary.

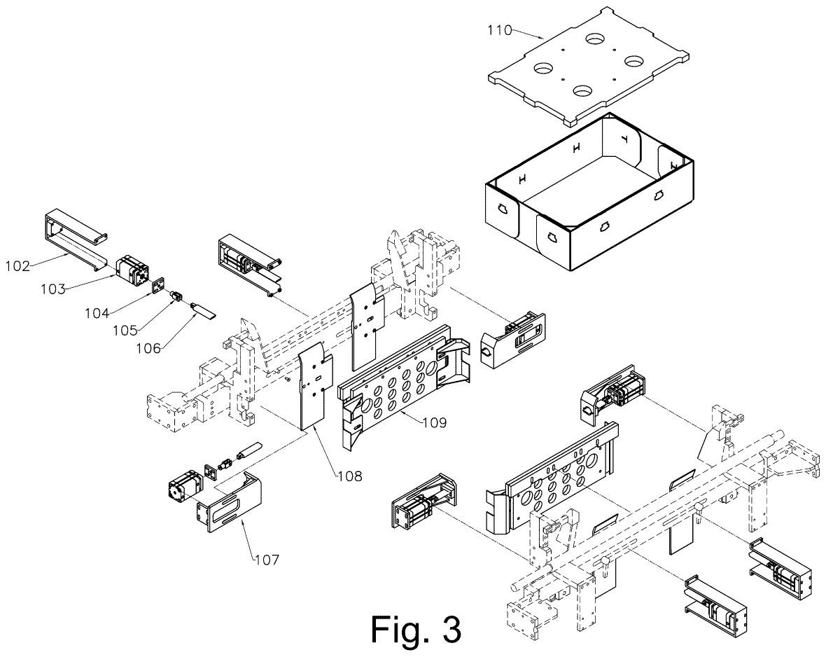

FIG. 3 shows an exploded view of the lock actuation arrangement of the horizontal assembly arrangement for the box with a rectangular base (that is, without beveled corners), designed for the example of box assembly with 8 locks and 8 interlocks of this invention.

The existing parts in known machines are shown in dotted lines, and in solid lines all the specially designed parts that make up the arrangement of the second embodiment of the present invention. The set of all these parts is known as the machine shaper. The example for assembling boxes with 8 locks and 8 interlocks includes:

Front Cylinder Supports 102. Qty: 4

Actuator Cylinders 103. Qty: 8

Finger position regulation plates 104. Qty: 8-Anchor forks 105. Qty: 8

Locking fingers 106. Qty: 8

Side cylinder supports 107. Qty: 4

Forming plates 108. Qty: 4

Turning plates 109. Qty: 2

Mandrel 110. Qty: 1

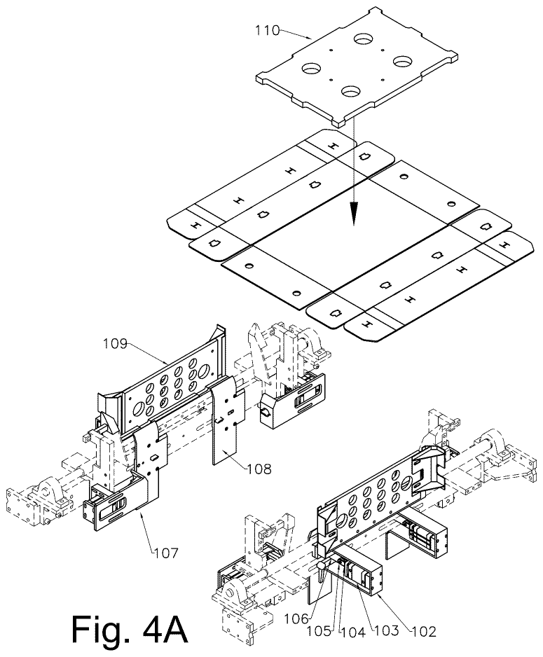

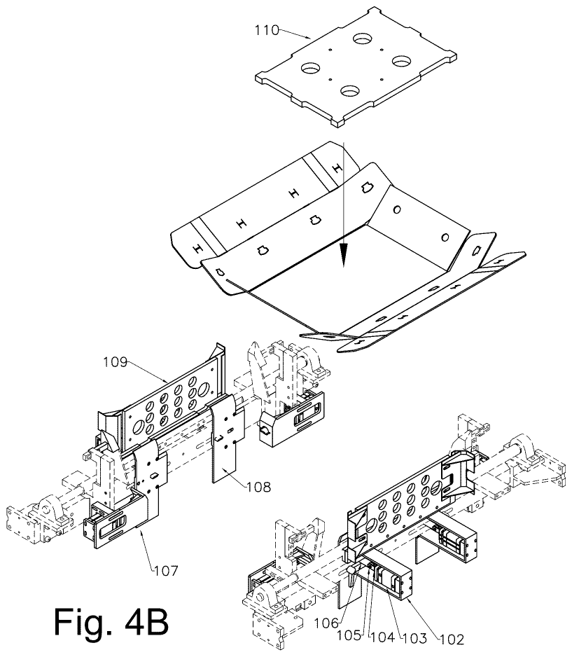

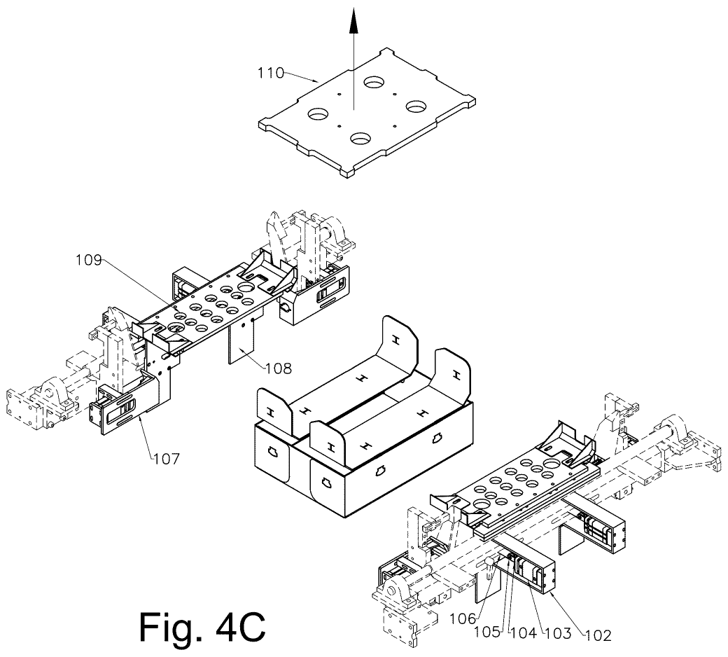

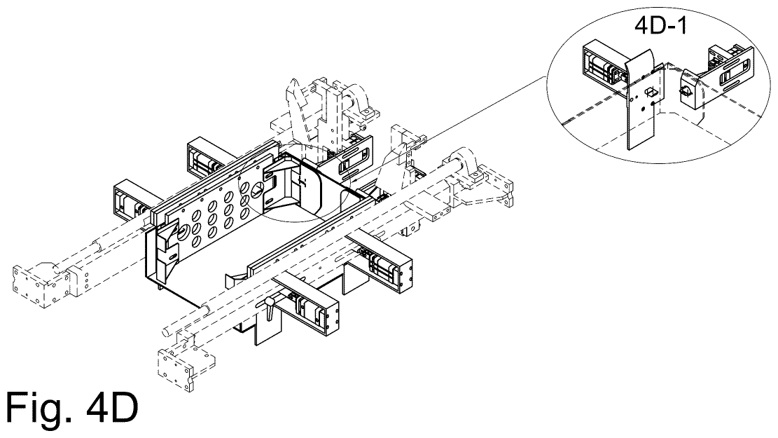

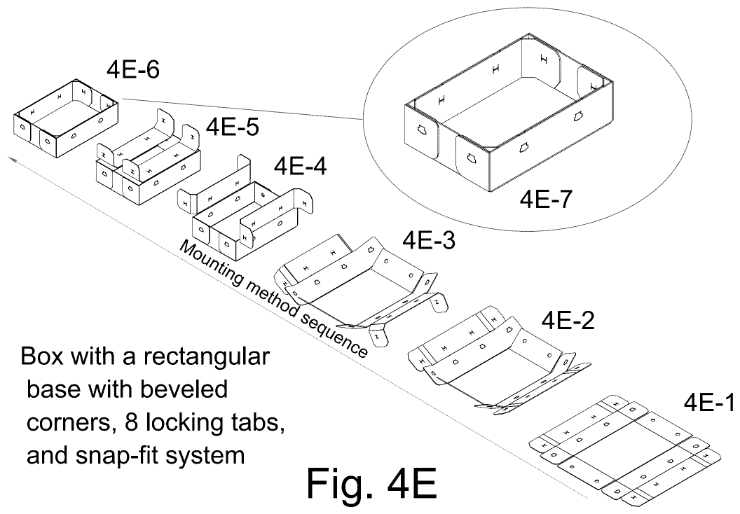

FIG. 4A shows the action of the mandrel on the corrugated cardboard sheet, before entering the forming machine.

FIG. 4B shows the action of the mandrel on the corrugated cardboard sheet, entering the forming machine.

FIG. 4C shows the corrugated cardboard sheet, inside the former of the machine, the turning plates beginning to act and the mandrel withdrawing.

FIG. 4D shows the corrugated cardboard sheet, inside the machine former, with the turners activated. In the detail you can see the corner of the box in a dotted line and the interlocking fingers.

FIG. 4E shows the assembly sequence of the box with a rectangular base with 8 locks and interlocks, starting as a flat corrugated cardboard sheet in FIG. 4E-1, until reaching a shaped box in FIG. 4E-6. The sequence 4E-1 to 4E-5 is armed with conventional systems; the locking fingers act in position 4E-6.

The arrangement of this invention was conceived to be mounted on the different existing box-assembling machines of our own design. These known machines Are suitable for assembling cardboard boxes and gluing them with hot-melt adhesive.

The arrangement of this invention adds the possibility that these machines can assemble cardboard boxes without using adhesive.

The arrangement is made up of several mechanical parts of our own design and commercial pneumatic cylinders. The combination of all the pieces enables the transversal movement of pieces called the machine's locking fingers, which perform the individual locking of each box lock.

Each box lock corresponds to a pneumatic cylinder (total quantity: 8), which, when activated, transmits movement to each of the machine's locking fingers that insert the box lock into the corresponding die-cut. When the finger is removed from the interlock (through pneumatic retraction) the box lock remains in its position, allowing to fix the box assembly.

The parts numbered and described in FIG. 3 are part of the special assembly kit that forms this second embodiment of the arrangement of the present invention.

The mandrel 110 pushes the corrugated board sheet onto the former. Once the box is folded inside the former contained by the plates 108, the turning plates 109 are activated, folding the lateral reinforcement of the box. After completely folding, the actuating cylinders 103 (ADNGF 40-40) activate the locking fingers 106, leaving the box locked in position.

Using the elements of this invention, the assembly of the box is carried out by the action of mechanical movements without the use of any type of adhesive.

The assembly method sequence for the second embodiment is as follows:
1.—The box is formed by introducing it inside the former by means of the mandrel 110 of FIG. 3.
2.—The turners 109 are activated folding the side reinforcements of the box.
3.—The side and front interlocks of fingers 106 are activated (total 8 pushing fingers) through a pneumatic cylinder 103. This action is performed by the turners 109, in folded position.

1. A system for mounting on an automatic horizontal assembly machine to assemble a corrugated cardboard box with a rectangular base and beveled corners, comprising multiple locks and interlocks and enabling assembly without adhesives, characterized by including a forming structure consisting of:
i) multiple deflectors (1);
ii) multiple front cylinder supports (2);
iii) multiple actuating cylinders (3);
iv) multiple position adjustment plates for fingers (4);
v) multiple anchoring forks (5);
vi) multiple interlocking fingers (6);
vii) multiple lateral cylinder supports (7);
viii) multiple forming plates (8);
ix) multiple turners (9); and
x) a mandrel (10);
where the mandrel (10) is able to push the corrugated board into the forming structure, the deflectors (1) perform the initial folding, the folding plates (9) fold the upper section of the box, and the actuating cylinders (3) drive the interlocking fingers (6), securing each lock into position and achieving complete box assembly.

2. The system according to claim 1, where the corrugated cardboard box with a rectangular base and beveled corners includes 8 locks and 8 interlocks, characterized by including:
i) 2 deflectors (1);
ii) 4 front cylinder supports (2);
iii) 8 actuating cylinders (3);
iv) 8 position adjustment plates for fingers (4);
v) 8 anchoring forks (5);
vi) 8 interlocking fingers (6);
vii) 4 lateral cylinder supports (7);
viii) 4 forming plates (8);
ix) 2 turners (9); and
x) 1 mandrel (10);

3. A system for mounting on an automatic horizontal assembly machine to assemble a corrugated cardboard box with a rectangular base, comprising multiple locks and interlocks and enabling assembly without adhesives, characterized by including a forming structure composed of:
i) multiple front cylinder supports (102);
ii) multiple actuating cylinders (103);
iii) multiple position adjustment plates for fingers (104);
iv) multiple anchoring forks (105);
v) multiple interlocking fingers (106);
vi) multiple lateral cylinder supports (107);
vii) multiple forming plates (108);
viii) multiple turners (109); and
ix) 1 mandrel (110);
where the mandrel (110) can push the corrugated board into the forming structure, the forming plates (108) hold the box as the folding plates (109) fold a side reinforcement, and the actuating cylinders (103) activate the interlocking fingers (106), securing the box in place.

4. The system according to claim 3, where the corrugated cardboard box with a rectangular base includes 8 locks and 8 interlocks, characterized by including:
i) 4 front cylinder supports (102);
ii) 8 actuating cylinders (103);
iii) 8 position adjustment plates for fingers (104);
iv) 8 anchoring forks (105);
v) 8 interlocking fingers (106);
vi) 4 lateral cylinder supports (107);
vii) 4 forming plates (108);
viii) 2 turners (109); and
ix) 1 mandrel (110);

5. A method for the automatic assembly of a corrugated cardboard box with a rectangular base and beveled corners, comprising multiple locks and interlocks, through the system described in claim 1, characterized by the following steps:
a) Inserting the cardboard sheet into the forming structure using the mandrel (10);
b) Activating the folding plates (9) to fold the upper section of the box;
c) Activating the side and front interlocking fingers (6) via pneumatic cylinders (3), with the folding plates (9) in a folded position.

6. The method according to claim 5, applied to a corrugated cardboard box with a rectangular base and beveled corners characterized by 8 locks and 8 interlocks.

7. A method for the automatic assembly of a corrugated cardboard box with a rectangular base, comprising multiple locks and interlocks, through the system described in claim 3, enabling adhesive-free assembly, characterized by the following steps:
a) Inserting the box into the forming structure using the mandrel (110);
b) Activating the folding plates (109) to fold the side reinforcements;
c) Activating the side and front interlocking fingers (106) via pneumatic cylinders (103), with the turners (109) in the folded position.

8. The method according to claim 7, applied to a corrugated cardboard box with a rectangular base, characterized by 8 locks and 8 interlocks.
